(19) United States
(12) Patent Application Publication
(10) Pub. No.: US 2004/0237820 A1
(43) Pub. Date: Dec. 2, 2004

(54) Wire rod for applying developer in a belt-type lithographic plate processor

(76) Inventors: Howard A. Fromson, Stonington, CT (US); William J. Rozell, Vernon, CT (US)

Correspondence Address: ALIX YALE & RISTAS LLP, 750 MAIN STREET, SUITE 1400, HARTFORD, CT, 06103, US

(21) Appl. No.: 10/869,273

(22) Filed: Jun. 16, 2004

Related U.S. Application Data
(63) Continuation-in-part of application No. 10/446,357, filed on May 28, 2003, now Pat. No. 6,793,418.

(51) Int. Cl. B41N 3/00

(52) U.S. Cl. 101/463.1

(57) ABSTRACT

The invention is directed to the development of lithographic printing plates by the application of a thin film of developer solution to each plate in a controlled manner using a wire-wound coating device that resists wetting-out of the solution. The exposed surface of the wire-wound coating device has a surface energy of no more than 24 dynes/cm, preferably less than about 20 dynes/cm, which can be achieved, for example by PTFE or FEP. The fluid is gently fed onto the wire-wound device by simple volumetric displacement.

### RELATED APPLICATION

This application is a continuation-in-part of U.S. application Ser. No. 10/446,357 filed May 28, 2003, the benefit of which is claimed under 35 U.S.C. Sec. 120.

### BACKGROUND OF THE INVENTION

The present invention is directed to a method and apparatus for applying a uniform film of fluid to a flat surface being conveyed through a workstation and specifically for applying a uniform film of developer to lithographic printing plates in a developing station. The invention is particularly directed to the use of a wire-wound rod for uniformly distributing the fluid over the workpiece and to the technique for metering and delivering the fluid to the wire-wound rod. The present invention is applicable to various planar workpieces and various types of workstations but is particularly applicable to lithographic printing plates which have been imaged and require the application of a developer to remove the areas of the coating on the plate which have been rendered soluble by the imaging process. Although the invention has a broader application, it will be described with particular reference to lithographic printing plate development.

One method for the development of the imaged plates entails the application of a thin film or layer of developing solution to the imaged plate surface of each imaged plate to be developed. This thin film of developer solution is allowed to dwell on the plate for a time sufficient to complete the development and then rinsed from the plate. Because only a thin film of developer solution is applied to each plate, any variation of any part of the surface of the plate from being substantially flat and horizontal and any variation in the thickness of the film of developer and any variation in the dwell time of the developer on different areas of the plate can result in the improper development of the coating.

The use of a wire-wound rod as a coating means is well suited to the continuous coating of web materials with a fluid, and well known in the art. Typically, a wire-wound coating rod is used in a coating method where some volume of fluid is continuously applied to the web surface prior to the rod, and the rod serves to meter the amount of fluid allowed to remain on the web surface. However, the coating of individual, discrete plates requires the ability to precisely initiate the coating process and precisely terminate the coating process on individual plates delivered at irregular intervals. In the case of lithographic printing plates, the developer fluid must be applied in the correct amount uniformly distributed across the width and length of the plate, with minimal waste.

The use of a wire-wound rod in metering the developer in a lithographic plate processor is known in the art. U.S. Pat. No. 4,737,810 teaches the application of excess developer with the wire-wound rod serving as the means to meter off the excess into some recovery means. The rod thus serves as the means to control the volume of fluid consumed in the development process. The developer fluid is applied to the plate ahead of the wire-wound rod and it is indicated in this patent that the path between the delivery of the fluid and the metering at the wire-wound rod is sufficiently short that development does not commence within this area. The excess developer removed in this area is intended to be reused.

Typical imaging methods include exposure to radiation and writing by ink jet. As is well known in the art, the imaging process renders the coating soluble in the imaged areas of a positive-working plate and renders the coating insoluble in the imaged areas of a negative-working plate. In either case, it is the coating which has been rendered soluble or the coating which has remained soluble that is removed. The particular compositions of the developer solutions for these different types of printing plates are well known. For example, many of the printing plates currently in use are positive-working plates and have coatings that contain alkali-soluble resins, specifically phenolic or acrylic resins. These coatings usually contain dissolution inhibitors that render them insoluble in the alkaline developers. The imaging process reverses this dissolution inhibition and the coating then becomes soluble in the areas subjected to the imaging radiation.

Excess developer that has been applied to the surface, metered off by a wire-wound rod, and subsequently recovered has been exposed to the atmosphere, and as such is subject to degradation. It is well documented in the art that atmospheric carbon dioxide rapidly reduces the alkalinity of aqueous alkaline developers of the type very commonly used in the processing of positive-working plates. Thus the recovered developer that is being reused will not have the same alkalinity as fresh, new developer. This recovered developer is in fact therefore reused in a way that with each application of developer to the plate, some fraction of the developer metered off by the wire-wound coating rod will have been removed in a previous cycle of development. Thus the repeated exposure to carbon dioxide and resultant degradation will further alter the effective alkalinity of the developer. Further, if the developer is applied some distance ahead of a wire-wound rod, some degree of development is certain to take place and it may very well be uneven.

With positive-working plates, the difference in the solubility of the imaged and non-imaged areas of the coating is generally less than the difference in solubility for negative-working plates. For that reason, the development process is more critical for positive-working plates. Also, the development mechanism for positive-working plates is a percolation process and a quiescent film of developer solution is critical. Any relative movement between the developer and the surface of the plate must be minimized or eliminated. Furthermore, the film of developer must be uniform with no bubbles. For these reasons, it is critical how the developer is applied to the plate.

### SUMMARY OF THE INVENTION

The present invention is directed to an improved apparatus for applying a uniform film of a developer fluid to the surface of a flat imaged lithographic plate using a wire-wound rod applicator, as the plate is being conveyed through a belt-type processor.

The invention is specifically directed to the development of lithographic printing plates and comprises a novel system for applying a thin film of developer solution to each plate in a controlled manner using a wire-wound coating rod on which the solution does not wet out. The non-wetting out effect is achieved by assuring that the exposed surface of the winding or helix has a low surface energy, for example less than about 24 dynes/cm and preferably no more than about 20 dynes/cm. Polytetrafluoroethylene (PTFE), which has a surface energy in the range of about 18-20 dynes/cm, is a preferred material for the exposed surface of the wire wound applicator rod. The developer fluid is gently fed into or onto the wire-wound rod over a portion of its axial length corresponding to the width of the plate. Due to the non-wetting out effect, the fluid does not spread out significantly along the applicator rod beyond the width of the plate. Thus, no significant volume of developer is wasted by excess flow onto the conveyor belt. The developer is allowed to dwell on the plate as it is conveyed horizontally across a platen or other support structure for a sufficient time to allow for percolation into and/or dissolution of the soluble areas of the coating.

### BRIEF DESCRIPTION OF THE DRAWINGS

FIG. 1 is a general diagrammatic sketch of a coating apparatus, specifically a lithographic printing plate developer, incorporating the novel method and apparatus for the present invention for applying a uniform film of fluid to a moving flat surface.

FIG. 2 illustrates one embodiment of the use of a wire-wound rod and fluid delivery means for applying the fluid to the surface.

FIG. 3 illustrates a second embodiment of the wire-wound rod.

FIG. 4 illustrates a further embodiment for delivering the fluid to the wire-wound rod.

FIG. 5 is a cross section of the wire-wound rod and fluid delivery tube of FIG. 4.

### DESCRIPTION OF THE PREFERRED EMBODIMENTS

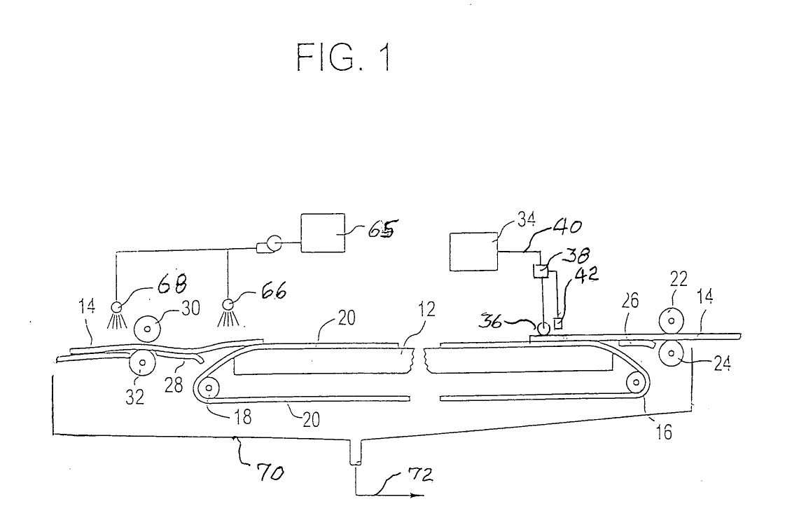

FIG. 1 is a diagrammatic drawing illustrating the general arrangement for practicing the invention, representing the equipment and method for developing an imaged lithographic printing plate. The developer apparatus comprises a substantially horizontal support structure which is preferably a platen 12 which may be any flat, horizontal surface composed of materials which will be unaffected by the particular developer solution to be used. In the context of the present invention and as used herein, the terms substantially flat and or substantially horizontal are defined as deviating from flat and/or horizontal only to the degree that the developer solution applied to the plate does not flow over or off of the surface of the plate. That is, the developer solution will remain as a film on the plate and have a thickness that produces uniform development over the entire area of the plate. The printing plate 14, which has been exposed and thus imaged, is carried across the platen 12 by means of a conveyor which comprises the conveyor drive rollers 16 and 18 and a continuous flexible conveyor belt 20. The conveyor belt 20 is composed of a material which will be unaffected by the developer solution, such as stainless steel or a polymer material. The printing plate 14 is fed by the feed rollers 22 and 24 onto the feed platform 26 which directs the printing plate onto the conveyor belt 20 for transport across the platen 12. After processing, the printing plate is guided by the discharge platform 28 into a pair of discharge rollers 30 and 32. Although the flat platen is the preferred support structure, other supports can be employed for the conveyor belt. For example, the support structure could be a series of rollers that have a small diameter and are closely spaced such that they provide adequate support to maintain a flat plate. Also, although the drawing depicts a conveyor belt for conveying the plate across the support structure, other conveying means could be employed. Merely as one example, the plate can initially be conveyed across a support structure such as a platen by the feed rollers for the plate and it can then be further conveyed the remaining distance directly by small driven rollers.

We have discovered that by using a fluorocarbon-coated wire wound rod having an exposed surface exhibiting low surface energy (e.g., no more than about 24 dynes/cm and preferably a PTFE at 18-20 dynes/cm or fluorinated ethylene propylene (FEP) at 18-22 dynes/cm): (1) the consumption of coating solution can be reduced due to reduction in lateral losses and (2) there is less tendency for the developed plate to exhibit scratches after development. Solid fluorocarbons within this surface energy range include polyhexafluoropropylene (16 dynes/cm) and chlorotrifluoroethylene (20-24 dynes/cm).

The invention is especially effective in a wire rod configuration wherein a hollow supply tube with a predetermined series of holes or slots defining a working length corresponding to the plate width, is positioned above a wire wound coating rod. In the preferred embodiment, the developer is delivered to the tube by a peristaltic pump, and overflows from the holes or slots onto the wire wound rod. Upon deposition on the applicator rod, the fluid covers the rod along a similar working length. Due to the low surface energy of the rod, the fluid remains on the rod over an axial distance that does not significantly exceed the working length of the supply tube.

Since a relatively thin film of developing fluid is applied, the strength of the developer fluid is relatively high. For coatings that are processed with alkaline developers, this means a higher alkalinity than that used in a conventional sump processor. Imperfections in the coated film integrity resulting from scratches or scuffs become sites where the aggressive nature of the developer attacks and removes the coating. Because materials that exhibit low surface energy not only resist wetting-out, but also tend to have low coefficients of friction, contact between the inventive applicator rod and the imaged plate produces far fewer scratches than occur with untreated applicator rods.

In particular, with a belt-type developer system, excess developer consumption could arise from losses resulting from lateral travel of the developer along the wire wound coating rod to areas of the belt beyond the edges of the plate. When using a stainless steel wire wound rod, for example, these losses are increased as a result of the tendency of the developer to wet out the rod. When the wire rod presents a low friction, non-wetting surface, such as the Teflon® brand of PTFE, the developer does not wet out the rod surface efficiently, and the tendency to travel along the length of the rod in a lateral direction is greatly reduced. This improves the efficiency of developer consumption by reducing the lateral losses, while also reducing scratches.

The wire-wound rod coating system includes means for metering and feeding the developer solution to the rod to control the thickness and assure the uniformity of the developer solution on the plate. In contrast to the known techniques where an excess of fluid is applied and subsequently metered off by the wire-wound rod, the present invention delivers precisely the required volume of developer at precisely the rate required to obtain a uniform film of developer on the plate in the amount needed to process the plate with very little excess. The preferred means for controlling the volume of developer delivered and the rate at which it is delivered is a peristaltic pump. The delivery of the developer is commenced at the beginning of the plate and continues at the appropriate rate of flow until the end of the plate where it is stopped. The wire-wound rod in the present invention is a means for ensuring the uniform distribution of the developer across the surface of the plate since with the close proximity of the applicator rod with the plate, preferably freely rolling thereon, there is little if any excess developer to be removed from the plate. Thus all problems with developer degradation that arise from the recirculation of excess developer are eliminated.

In the context of the present invention, the term “wire-wound” includes what are termed “formed rods”. These formed rods are manufactured by machining a rod or tube to produce a rolled thread-like, helical profile that duplicates the pitch and radius of the rods formed by winding wire and are to be understood to be the equivalent of rods formed by winding wire onto a core.

Preferably, a peristaltic pump is used as the means for delivering the developer directly or indirectly to the wire rod. The pump commences operation when the leading edge of the plate is detected by a sensor. The volume of developer delivered by the peristaltic pump causes an equal volume of developer to overflow through the slots or holes onto the outer surface of the wire wound rod, where it is distributed evenly across the plate width as the helix rotates. The pump rate is matched to the plate speed and developer quantity requirement to maintain a uniform coverage along the length of the plate. The pump stops in conjunction with the sensing of the trailing edge of the plate. In FIG. 1, this is diagrammatically illustrated by the developer supply drum 34, the wire-wound rod 36, the developer pump 38, the developer feed line 40 and the plate sensor 42 such as a photoelectric sensor.

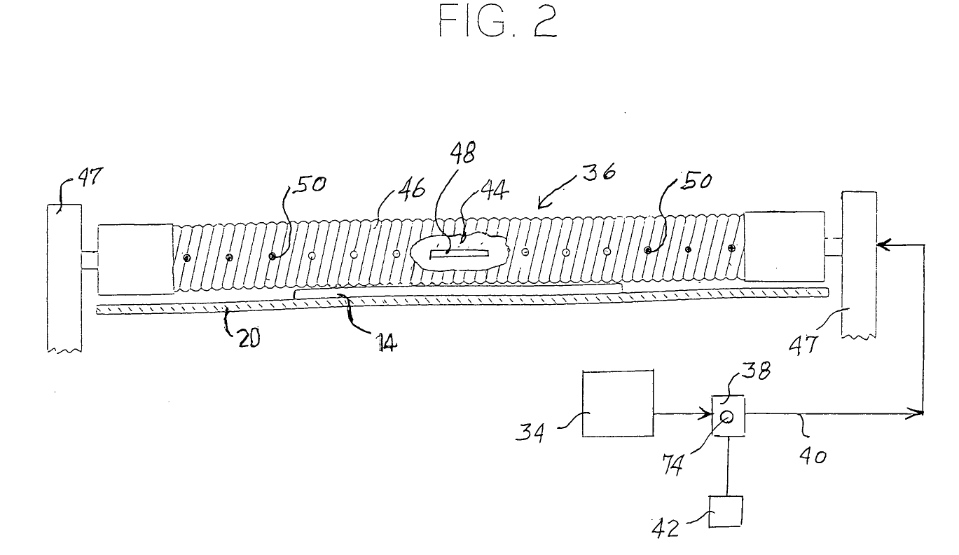

FIG. 2 shows one embodiment of a wire-wound rod and the means for metering and feeding the developer to the wire-wound rod. The rod itself actually comprises a hollow tube 44 with the wire 46 being spirally wound around the tube. The tube is mounted for adjustable vertical positioning in the frame members 47, without rotation. Located along one side of the tube 44 are slots 48 extending through to the inside of the tube. Although only one slot 48 is shown in FIG. 2 through the cutaway opening in the wire 46, a series of slots are lined up along the side of the tube which faces upstream with respect to the direction of travel of the plate. Merely as an example, these slots may be 1/16 inch wide by 1/2 inch long with 1 inch between slots. Small holes 50 are formed through the layer of wire between adjacent wraps of the wire with these holes lining up with the slots 48. The developer is fed to the inside of the tube 44 from the supply drum 34 through the flexible tube 40 which goes through the preferred peristaltic pump 38. The pump is switched on and off by the plate sensor 42. The developer exits through the slots 48 and holes 50 and runs down over the wire-wound rod onto the plate 14. In general, the thickness of the fluid applied is equal to about 9% or 10% of the diameter of the wire on the rod.

For minimizing developer loss and thus volumetric efficiency, the extent of holes 50 at the surface in the rod axial direction, should match the width of the plate. Different rods 36 can be used for different size plates, or the holes 50 can be selectively plugged or unplugged. The low-friction, non-wetting wire surface promotes a more uniform deposition of fluid, and minimizes lateral spreading of the fluid along the wire beyond the width of the plate. Also, irregularities in belt or plate flatness can produce momentary contact between the wire and the plate, but the low friction surface of the wire minimizes the chances of scratching.

As used herein, “non-wetting” means that the surface has low surface energy such that aqueous fluids of the type typically used for developing lithographic printing plates do not cling to the surface, but rather run or slide off. This is preferably achieved by employing a winding wire that was precoated with, e.g., a fluorocarbon polymer, before winding on the core, or such coating was applied to the winding wire or formed rod after assembly. Further as used herein, “exposed surface” means at least the surfaces of the helix that are visible. Any continuous coating thickness would be satisfactory, but thicker coating would naturally have a longer useful life.

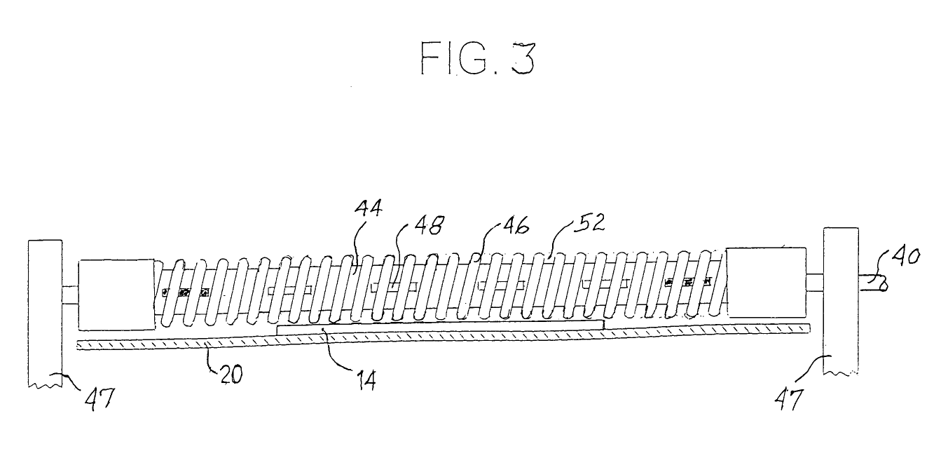

Another embodiment of the wire-wound rod of the present invention is shown in FIG. 3. The tube 44 still has the slots 48 but the spirally wound wire 46 is loosely wound with gaps 52 between adjacent winds. These gaps permit the fluid to flow out from the slots 48 between the wires. The relative sizes of the wire and gap are distorted in FIG. 3 for clarity. As an example, the wire would be on the order of 0.010 inches (10 mils) in diameter while the gap would be on the order of 0.001 inches wide. The gap needs to be just wide enough to permit the fluid to flow through at the necessary rate.

As with the embodiment of FIG. 2, the extent of slots 48 in the direction of the rod axis, should correspond to the width of the plate, and different rods can be selected to match different size plates. The same benefits of a low-friction, low wetting surface of the wire are also realized in this embodiment.

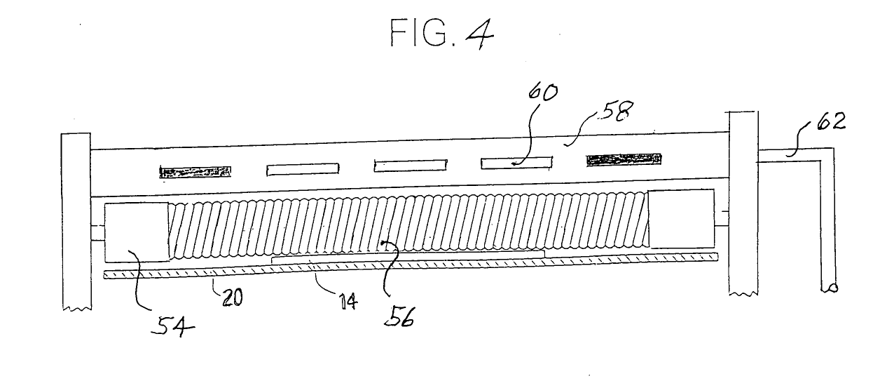

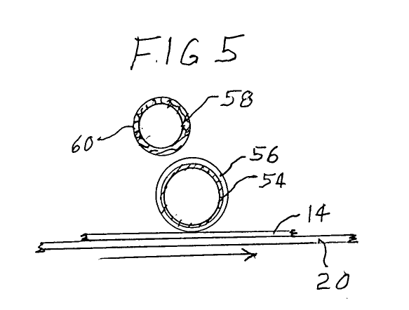

A further and most efficacious embodiment of the invention is shown in FIGS. 4 and 5. In this embodiment, the fluid feeding or supply tube is separate from the rod on which the wire is wound. The rod 54 preferably comprises a solid core to achieve a substantial weight, closely wound with the wire 56. The rod 54 is mounted in the frame 47 to rotate freely with unrestrained vertical movement, while restrained from displacement horizontally, i.e., in the belt conveying direction. For a tightly wound rod or formed wire as shown in FIG. 4, the fluorocarbon coating can be applied on the helical surface as the last step of fabrication. Alternatively, the wire could be fully coated before winding on the core. The former technique is preferred because less coating material is needed and for rods that may not require closely packed windings, the exposed core would also be coated.

In applications where the fluid is a low viscosity fluid and the film thickness is small, it is particularly advantageous to match the circumferential surface speed of the wire-wound rod to the conveyor belt speed to reduce any tendency of the wire-wound rod to scratch the surface of the plate. An effective way of assuring this matched speed, is for the wire rod to be mounted in the frame for passive rotation, whereby the belt itself rotates the wire rod. As the plate is conveyed by the belt into contact with the rod, the rod continues to rotate as it rides up onto the leading edge of the plate. The plate remains trapped beneath the rod, while the rod continues to rotate and apply fluid at the leading exposed surface of the rod. However, there is no relative movement between the instantaneous contacting surface of wound wire and the plate, or between the plate and the belt. As the rod rotates, the rotating helical grooves formed by the helical windings assure complete coverage of fluid on the plate. The mounting of the rod provides a vertically free-floating support such that the weight of the rod is borne by the plate, without the need for any external vertical resistance or hold-down force (although the invention does not preclude external means for optimization of the effective pressure applied by the rod against the belt or plate).

In this embodiment, a fluid supply tube 58 is mounted above the rod 54. This fluid supply tube, which may be cylindrical as illustrated or any other desired cross-sectional configuration, is provided with the slots 60 similar in function to the slots 48 in FIGS. 2 and 3. Analogously, the extent of open slots 60 in the direction parallel to the rod axis, should correspond to the width of the plate 14. Plugged slots 60 are represented as darkened areas. The benefits of a low-friction, low wetting surface of the wire are especially advantageous in this embodiment, because of the desired continuous contact between the exposed surface of the rod and the plate. The fluid is supplied to the fluid supply tube 58 through the feed line 62. The fluid supply tube is mounted above the rod 54 such that the fluid will run down the fluid supply tube and flow onto the exposed surface of the rod 54 on the upstream side of the rod 54. This is shown in FIG. 5 where the arrow 64 shows the direction of movement of the conveyor and plate and the tube 58 is located slightly upstream from the rod 54. This assures that all of the fluid fed onto the plate is subjected to the action of the wire-wound rod and not run down onto the plate on the downstream side of the rod. Upon applying developer to the trailing edge of the plate, the rod rides down over this edge and fully contacts the moving belt.

The printing plate that has been coated with the developer solution continues to travel across the platen. The length and speed of travel is selected such that the developer solution will have completed the development process by the time the printing plate reaches the discharge end of the platen. A typical development time is 20 to 60 seconds. At this point, rinse water from the supply 65 is sprayed onto the plate through the spray nozzles 66 and 68. Located below the conveyor structure is a collection pan 70 which collects all of the liquid run off from the printing plate including the spent developer solution and rinse water now containing the portion of the coating which has been dissolved away. The developer solution that is rinsed from the plate is collected at 72 and sent to waste. It can be seen that there is always only fresh developer solution being applied to the plates and that there is only a small quantity of developer solution applied to each plate. It has been discovered that the consumption of developer solution can be reduced by as much as 50% when compared to a conventional printing plate development processor.

It is important that the thin film of developer solution be substantially uniformly distributed over the entire upper, imaged surface of the plate as it is being conveyed across the platen. This requires that the plate on the conveyor be substantially flat and substantially horizontal or level and begins with having a substantially flat, horizontal support structure and, therefore, a substantially flat horizontal conveyor belt. Since the printing plates are very thin and flexible, surface tension is used to hold the plate firmly in position and flat on the conveyor belt. For example, this can be accomplished by providing a film of water between the plate and the conveyor belt. This surface tension also facilitates a smooth transition where the rod rides up onto and then off of the plate.

A simple volumetric displacement and overflow configuration is used as the means for controlling the rate and volume of fluid applied to the plate. Referring back to FIGS. 1 and 2, the pump 38 commences when the leading edge of the plate is detected by the sensor 42. The volume of fluid delivered by the pump is adjusted by the speed control dial which is matched to the plate speed and quantity of fluid required to maintain a uniform coverage along the length of the plate. The volume of fluid delivered by the pump causes an equal volume of fluid to overflow through the slots or holes out onto the wire. The pump stops as a function of the sensing of the trailing end of the plate. Although other low pressure pumps could be used, the preferred pump is a peristaltic pump which offers good control of volume and flow rate. Also, there is rapid response to switching the flow on and off. The fluid only comes in contact with the tubing so chemically aggressive fluids can be accommodated. Further, the gentle pumping action reduces problems with foaming that can occur with pressurized systems. A uniform film of fluid is gently applied to the plate without bubbles to produce a quiescent film suitable for uniformly developing printing plates. Another method of feeding the fluid is by gravity flow from a raised reservoir including level control means to maintain a constant head in the reservoir. A valve in the feed line from the reservoir is triggered by the detection of the leading and trailing ends of the plate by the sensor. This embodiment is also represented in FIG. 1 when the supply drum 34 is a gravity feed reservoir and the item numbered 38 is the control valve. As a further feature of the invention, the fluid is applied to the plate and coincidentally uniformly spread over the plate at the required thickness. This contrasts sharply with prior art arrangements where the fluid is applied to the plate some distance ahead of the wire-wound rod.

An 830 plate commercially available from Anocoil Corporation, Rockville, Conn., was thermally imaged by infrared on a Creo/Scitex Trendsefter Imager, commercially available from Creo/Scitex, Vancouver, British Columbia, Canada. The plate was imaged at an exposure of 200 mj/cm². The image comprised halftone target areas at a 175 line per inch ruling.

A processor was constructed as depicted in FIGS. 1, 4, and 5. A wire-wound coating rod was positioned at the entry end of the continuous conveyor belt. The tube 58 was placed in the processor on the continuous conveyor belt so that the axis of the tube was perpendicular to the direction of travel of the belt and the orientation of the slots 60 was toward the plate entry end of the processor. One end of the tube was capped and the other end was fitted with a flexible tubing connection. The tube was connected to a variable flow peristaltic pump available from VWR International of Bridgeport, N.J.

A ⅝″ diameter stainless steel rod 54 wound with 0.022″ diameter stainless steel wire 56 was used. The wire rod was supported for free rotation against the belt. Processing of the Anocoil 830 T plate using a developer comprising an aqueous sodium metasilicate solution applied with the wire rod as the distribution means, resulted in a substantial number of small scratches observed on the plate. Subsequently an identical ⅝″ diameter stainless steel rod wound with 0.022″ diameter stainless steel wire, was coated with a thin covering of Teflon® brand PTFE. An identical Anocoil 830 T plate was processed using this Teflon coated rod as the distribution means, supported in the same manner as the uncoated rod. This plate showed none of the scratches evident on the previous plate.

1. A device for applying developer fluid to an imaged coating on of a lithographic printing plate, comprising:
means for horizontally conveying the plate;
a rod having a helical exterior surface;
means for supporting the rod horizontally for free rotation against the plate as the plate is conveyed; and
means for supplying said developer fluid to said exterior surface;
wherein the exterior surface has a surface energy of less than 24 dynes/cm.

2. The device of claim 1, wherein the exterior surface has a surface energy less than about 20 dynes/cm.

3. The device of claim 1, wherein the exterior surface is a fluorocarbon polymer.

4. A device for applying developer fluid to an imaged coating on a lithographic printing plate, comprising:
means for horizontally conveying the plate;
a rod having a helical exterior surface;
means for supporting the rod horizontally for free rotation against the plate as the plate is conveyed; and
means for supplying said developer fluid to said exterior surface;
wherein the exterior surface is a fluorocarbon polymer material.

5. A device for applying developer fluid to an imaged coating on a lithographic printing plate, comprising:
means for horizontally conveying the plate;
a rod having a helical exterior surface;
means for supporting the rod horizontally for free rotation against the plate as the plate is conveyed; and
means for supplying said developer fluid to said exterior surface;
wherein the exterior surface does not wet out by said developer fluid.

6. The device of claim 5, wherein the exterior surface has a surface energy less than 24 dynes/cm.

7. The device of claim 5, wherein the exterior surface has a surface energy less than about 20 dynes/cm.

8. The device of claim 5, wherein the exterior surface is a fluorocarbon polymer.

9. The device of claim 5, wherein the exterior surface is PTFE or FEP.

10. Apparatus for developing a lithographic printing plate having length and width dimensions and an imaged coating on a surface thereof comprising areas of coating insoluble in a selected developer solution and areas of coating soluble in said selected developer solution, said apparatus adapted to remove said soluble coating from said plate and comprising means for conveying said plate across a substantially horizontal support structure, means for applying developer solution to said imaged coating on said surface for a period of time necessary for said soluble coating to dissolve in said developer solution and produce a spent developer solution and a developed plate, and means for removing said spent developer solution from said developed plate and discharging said spent developer solution to waste wherein said means for applying developer solution comprises:
a horizontal cylindrical hollow tube having a plurality of apertures along the length on one side thereof;
a layer of spirally wound wire wrapped around said tube including openings through said layer of spirally wound wire for the flow of fluid;
means for feeding developer solution into said cylindrical hollow tube whereby said developer solution overflows from said cylindrical hollow tube through said plurality of apertures and through said openings whereby said developer solution flows down said wound wire onto said imaged coating;
wherein the wound wire has an exposed surface that is non-wetting to said developer solution.

11. The apparatus of claim 10, wherein the exterior surface has a surface energy less than 24 dynes/cm.

12. The apparatus of claim 10, wherein the exterior surface has a surface energy less than about 20 dynes/cm.

13. The apparatus of claim 10, wherein the exterior surface is a fluoropolymer.

14. The apparatus of claim 10, wherein the exterior surface is PTFE or FEP.

15. The apparatus of claim 10, including means for sensing the presence of a plate and controlling said means for feeding developer solution whereby developer solution is fed to said tube only when said plate is beneath said wound wire.

16. Apparatus for developing a lithographic printing plate having length and width dimensions and an imaged coating on a surface thereof comprising areas of coating insoluble in a selected developer solution and areas of coating soluble in said selected developer solution, said apparatus adapted to remove said soluble coating from said plate and comprising means for conveying said plate across a substantially horizontal support structure, means for applying developer solution to said imaged coating on said surface for a period of time necessary for said soluble coating to dissolve in said developer solution and produce a spent developer solution and a developed plate, and means for removing said spent developer solution from said developed plate and discharging said spent developer solution to waste wherein said means for applying developer solution comprises:
a horizontally supported wire wound rod;
a horizontal hollow tube having a plurality of apertures along the length on one side thereof, said tube being mounted above said wire wound rod;
means for feeding developer solution into said tube whereby said developer solution overflows from said tube through said plurality of apertures and flows down onto said wire wound rod;
wherein the wire wound rod has an exposed surface for receiving the flow of developer solution and applying said solution to said plate; and
said exposed surface is non-wetting to said developer solution.

17. The apparatus of claim 16, wherein the exterior surface has a surface energy less than 24 dynes/cm.

18. The apparatus of claim 16, wherein the exterior surface has a surface energy less than about 20 dynes/cm.

19. The apparatus of claim 16, wherein the exterior surface is a fluoropolymer.

20. The apparatus of claim 16, wherein the exterior surface is PTFE.

21. The apparatus of claim 16, including means for sensing the presence of a plate and controlling said means for feeding developer solution whereby developer solution is fed to said tube only when said plate is beneath said wire wound rod.

22. The apparatus of claim 16 wherein said wire-wound rod is supported horizontally to prevent horizontal displacement of the rod while permitting free rotation and free vertical movement.

23. The apparatus of claim 22, wherein said means for conveying the plate is a continuously moving belt riding at a processing speed on a rigid platen and said wire wound rod bears on said belt and is rotated at said speed by said belt when no plate is under said rod and when a plate is under said rod said rod bears on said plate and continues to rotate at said speed while applying developer solution to said plate.

24. The apparatus of claim 16, wherein the only apertures through which developer solution flows span a longitudinal distance along said tube that is substantially equal to said width dimension of the plate.

25. The apparatus of claim 24, including means for sensing the presence of a plate and controlling said means for feeding developer solution whereby developer solution is fed to said tube only when said plate is beneath said wound wire.

26. The apparatus of claim 25, wherein said means for conveying the plate is a continuously moving belt riding at a processing speed on a rigid platen and said wire wound rod bears on said belt and is rotated at said speed by said belt when no plate is under said rod and when a plate is under said rod said rod bears on said plate and continues to rotate at said speed while applying developer solution to said plate.

27. Apparatus for applying a developer fluid to an imaged lithographic printing plate having a width dimension, said apparatus comprising means for conveying said plate across a substantially horizontal support structure and a wire-wound rod for applying the developer fluid to said plate width as it is being conveyed, comprising:
a horizontally supported wire wound rod;
a horizontal hollow tube having a plurality of open apertures along a length on one side thereof corresponding to said plate dimension, said tube being mounted above said wire wound rod; and
means for feeding said fluid into said tube whereby said fluid overflows from said tube through said plurality of open apertures and flows onto said wire wound rod;
wherein the wire wound rod has an exposed surface that is non-wetting to said developer fluid.

28. The apparatus of claim 27 wherein said means for feeding a fluid into said hollow tube comprises a volumetric displacement pump.

29. The apparatus of claim 28 further including means for sensing the presence of a plate and controlling said means for feeding developer fluid whereby developer fluid is fed to said tube only when said plate is beneath said wire wound rod.

30. The apparatus of claim 29, wherein said means for conveying the plate is a continuously moving belt riding at a processing speed on a rigid platen and said wire wound rod bears on said belt and is rotated at said speed by said belt when no plate is under said rod and when a plate is under said rod said rod bears on said plate and continues to rotate at said speed while applying developer fluid to said plate.
